(19) United States
(12) Patent Application Publication
(10) Pub. No.: US 2026/0161669 A1
(43) Pub. Date: Jun. 11, 2026

(54) APPARATUS AND METHODS OF CATEGORIZATION AND CONFIGURATION OF DATA SETS

(71) Applicant: GCP INDUSTRIAL, Kitchener (CA)

(72) Inventors: Gary MOTTERSHEAD, Kitchener (CA); Craig MOTTERSHEAD, Kitchener (CA)

(73) Assignee: GCP INDUSTRIAL, Kitchener, ON (CA)

(21) Appl. No.: 19/119,223

(22) PCT Filed: Aug. 29, 2023
(86) PCT No.: PCT/CA2023/051140

§ 371 Date: Apr. 8, 2025

(51) Int. Cl. G06F 16/28

(52) U.S. Cl. CPC G06F 16/287

(57) ABSTRACT

An apparatus for categorization and configuration of data sets including a processor and a memory communicatively connected to the processor, the memory containing instructions configuring the processor to receive a data set, categorize the data set into at least one descriptor categorization, compare the data set to one or more validity thresholds as a function of the at least one descriptor categorization, and generate one or more data modules as a function of the comparison, wherein generating the one or more data modules includes selecting one or more end users as a function of the data set.

### FIELD OF THE INVENTION

The present invention generally relates to the field of user interfaces. In particular, the present invention is directed to an apparatus for categorization and configuration of data sets.

### BACKGROUND

Current systems configured to categorize and configure data sets are lacking due to inadequate validation processes. As a result, data sets may not contain the proper prerequisites for categorization and configuration. In addition, systems containing some sort of validation processes are generally static and do not allow for dynamic validation processes that are capable of catering to data sets of differing categorizations.

### SUMMARY OF THE DISCLOSURE

In an aspect an apparatus for categorization and configuration of data sets is described. Apparatus includes a processor and a memory communicatively connected to the processor. The memory contains instructions configuring the processor to receive a data set, categorize the data set into at least one descriptor categorization, compare the data set to one or more validity thresholds as a function of the at least one descriptor categorization and generate one or more data modules as a function of the comparison. Generating the one or more data modules includes selecting one or more end users as a function of the data set.

In another aspect a method for categorization and configuration of data sets is described. The method includes receiving, by at least a processor, a data set, categorizing, by the at least a processor, the data set into at least one descriptor categorization, and comparing, by the at least a processor, the data set to one or more validity thresholds as a function of the at least one descriptor categorization. The method further includes generating, by the at least a processor, one or more data modules as a function of the comparison, wherein generating the one or more data modules includes selecting one or more end users as a function of the data set.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for categorization and configuration of data sets;

FIG. 2 is an exemplary embodiment of a graphical user interface in accordance with this disclosure;

FIG. 3 is a block diagram of exemplary embodiment of a chatbot;

FIG. 4 is a block diagram of exemplary embodiment of a machine learning module;

FIG. 5 is a diagram of an exemplary embodiment of a neural network;

FIG. 6 is a block diagram of an exemplary embodiment of a node of a neural network;

FIG. 7 is a flow diagram illustrating an exemplary embodiment of a method for categorization and configuration of data sets; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to apparatuses and methods for categorization and configuration of data sets. In an embodiment, the present disclosure contains a computing device configured to receive a data set, determine the eligibility of the data set through one or more validation processes and determine one or more end users that can utilize the validated data set.

Aspects of the present disclosure can be used to determine conformity to industry standards through one or more validation processes. Aspects of this disclosure can further be used to find one or more end users that are capable of manufacturing and/or producing a particular product. Exemplary embodiments illustrating aspects of the present disclosure are described below in the context of several specific examples.

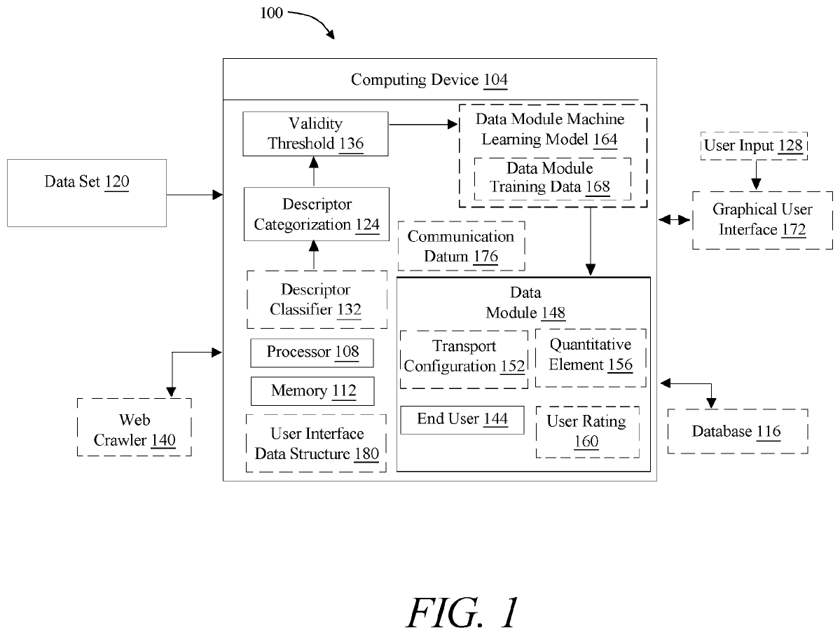

With continued reference to FIG. 1, an apparatus 100 for categorization and configuration of data sets is described. Apparatus 100 includes a computing device 104. Apparatus 100 includes a processor 108. Processor may include, without limitation, any processor described in this disclosure. Processor may be included in a and/or consistent with computing device 104. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device 104 operating independently or may include two or more computing devices operating in concert, in parallel, sequentially or the like; two or more computing devices may be included together in a single computing device 104 or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device 104. Computing device 104 may include but is not limited to, for example, a computing device 104 or cluster of computing devices in a first location and a second computing device 104 or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device 104, which may operate in parallel, in series, redundantly, or in any other manner used for distribution of tasks or memory 112 between computing devices. Computing device 104 may be implemented, as a non-limiting example, using a “shared nothing” architecture.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may perform determinations, classification, and/or analysis steps, methods, processes, or the like as described in this disclosure using machine-learning processes. A “machine-learning process,” as used in this disclosure, is a process that automatedly uses a body of data known as “training data” and/or a “training set” (described further below in this disclosure) to generate an algorithm that will be performed by a Processor module to produce outputs given data provided as inputs; this is in contrast to a non-machine learning software program where the commands to be executed are determined in advance by a user and written in a programming language. A machine-learning process may utilize supervised, unsupervised, lazy-learning processes and/or neural networks, described further below.

With continued reference to FIG. 1, apparatus 100 includes a memory 112 communicatively connected to processor 108. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, using a bus or other facility for intercommunication between elements of a computing device 104. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Still referring to FIG. 1, apparatus 100 may include a database 116. Database 116 may be implemented, without limitation, as a relational database, a key-value retrieval database such as a NOSQL database, or any other format or structure for use as database that a person skilled in the art would recognize as suitable upon review of the entirety of this disclosure. Database may alternatively or additionally be implemented using a distributed data storage protocol and/or data structure, such as a distributed hash table or the like. Database 116 may include a plurality of data entries and/or records as described above. Data entries in database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in database may store, retrieve, organize, and/or reflect data and/or records.

With continued reference to FIG. 1, processor 108 is configured to receive a data set 120. “Data set” for the purposes of this disclosure is a collection of related information that is sought to be validated prior to use within one or more algorithms. In some cases, data set 120 may include a collection of related information such as related information about an image (such as but not limited to, multiple sections of a larger image metadata of the image including location, time, date, light intensity, and the like), related information about a particular physical space (such as but not limited to, videos, images, temperature, humidity, weather, and the like), related information about a particular individual (such as but not limited to, age, gender, height, weight various physical features), and the like. In one or more embodiments, data set 120 may include information that is sought to be validated prior to processing. In one or more embodiments, data set 120 may be used to validate information about a particular product prior to processing. In one or more embodiments, data set 120 may include a product data set. “Product data set” for the purposes of this disclosure is a collection of related information associated with a particular product. For example, product data set may include information about a chair and corresponding characteristics of the chair. In another non-limiting example, product data set may include information about a baby bottle and corresponding information about the baby bottle. “Product” for the purposes of this disclosure is any article or substance that is manufactured or refined for sale. For example, product may include a chair, a water bottle, a water bottle filled with water, a packaged food item, a baby bottle and/or any other items that may be sold. Product data set may include information such as products specifications, wherein product specifications may include the length, the width, and the height of the product. “Product specification” for the purposes of this disclosure is information describing the characteristics of the product. For example, product specification may include the height, weight, length, and width of the product. Product specifications may further include materials in the product or materials required to manufacture the product, such as plastic, metals, paints, liquids, and the like. Product specification may further include components within the product such as batteries, computing systems, computing chips and/or any other devices associated with a computing system as described in this disclosure. product data set may further include the intended audience of a particular product. For example, product data set may include information indicating that the intended audience of a baby bottle is children under the age of 3. In some cases, product data set may further include hazards associated with the product, such as but not limited to, choking hazards, hazards related to toxicity, hazards relating to misuse and the like. In some cases, product data set may include the generic and generated name of the product. For example, a chair may contain a generic name as a chair and a generated name that associated the chair with a particular entity. “Entity” for the purposes of this disclosure, is an organization comprised of one or more persons with a specific purpose. An entity may include a corporation, organization, business, group one or more persons, and the like. In some cases, data set 120 may further include images of the product, 3D models of the product, 3D files, drawings and the like. In an embodiment, 3D models of the product may facilitate configuration of a particular product into one or more shipping containers. In some cases product data set may further include any information necessary for one to manufacture and package a product. In some cases, product data set may include information of an individual or business associated with the product. This may include, but is not limited to, a name, an address, a business logo, contact information (e.g., email, phone, etc.) and the like. In some cases, product data set may include instructions on how to create and/or manufacture the product. This may include but is not limited to particular methods of manufacturing, instructions and/or files configured to facilitate generating one or more molds and the like.

With continued reference to FIG. 1, in some cases, product specification may include industry specific product specification, this may include but is not limited to, specifications that are related to a particular industry, such as the food and beverage industry, the automotive industry, the medical devices industry, the aerospace industry, the baby products industry and the like. In embodiment, each industry may contain particular product specification. For example, the automotive industry, may require product specification such as the horsepower of a vehicle, the miles per gallon of the vehicle, the safety standards of the vehicle, crash test ratings, emissions, and the like. In another non limiting example, the food and beverage industry may include requirements such as ingredients, nutrition information, allergen information, expiration data and the like. In yet another non limiting example, a baby product industry may include requirements such as safety standards, age suitability, materials, chemicals, and the like.

With continued reference to FIG. 1, in situations where a product within data set 120 is an edible item, data set 120 may include the ingredients associated with the product, the nutrition facts associated with the product, potential allergies, and the like.

With continued reference to FIG. 1, data set 120 may further include packaging requirements. Packaging requirements, include but are not limited to, particular material of the packaging, particular graphical elements that are to be depicted on the packaging, various information and/or logs to be depicted on the package, dimensions associated with the packaging, particular handling requirements (e.g., refrigeration required, requirements to handle a fragile product, etc.) and the like. Packing requirements may further include barcodes, instructions for the product, warnings, country of origin and the like. Packing requirements may further include any requirements necessary for sale of a product.

With continued reference to FIG. 1, data set 120 may further include information indicating communication preference of an individual or business associated with a product. This may include a preference to communicate over text, over email, through a video call, through a phone call, in person and the like.

With continued reference to FIG. 1, data set 120 may further include manufacturing requirements. “Manufacturing requirements” for the purposes of this disclosure is one or more elements describing how a user would like their product produced or manufactured. This may include costs, such as a minimum price to produce, a maximum price to produce and the like. Manufacturing requirements may further include maximum manufacturing times, particular geographic locations of the manufacturing facilities (e.g. USA, China, etc.) and the like. In some cases, manufacturing requirements may further include requirements indicating that a user does or does not want particular materials within the product.

With continued reference to FIG. 1, data set 120 may further include a bill of materials. “Bill of materials for the purposes of this disclosure is the material and components required to manufacture a product and the amount of those materials or components. In a non-limiting example, bill of materials may include 4 screws, 20 grams of plastic, 20 grams of aluminum, 4 AA batteries, 2 feet of copper wiring, a processor 108, a computing system, an IOT (internet of things) device, a stepper motor and the like. In an embodiment, bill of materials may be used to indicate the type of materials required to produce a particular product and the corresponding amount of those materials.

With continued reference to FIG. 1, Data set 120 and/or data set 120 and/or elements thereof may be received by a chatbot system. A “chatbot system” for the purposes of this disclosure, is a program configured to simulate human interaction with a user with a user in order to receive or convey information. In some cases, chatbot system may be configured to receive data set 120 and/or elements thereof through interactive questions presented to the user. the questions may include, but are not limited to, questions such as “What is the name of your product?”, “What materials are required to create your product?”, “what is your geographic location?” and the like. In some cases, computing device 104 may be configured to present a comment box through a user interface wherein a user may interact with the chatbot and answer the questions through input into the chat box. In some cases, questions may require selection of one or more pre-configured answers. For example, chatbot system may ask a user to select the appropriate salary range corresponding to the user, wherein the user may select the appropriate range from a list of pre-configured answers. In situations where answers are limited to limited responses, chatbot may be configured to display checkboxes wherein a user may select a box that is most associated with their answer. In some cases, chatbot may be configured to receive data set 120 through an input. In some cases, each question may be assigned to a particular categorization wherein a response to the question may be assigned to the same categorization. For example, a question prompting a user to enter the dimensions of a product may be categorized in a size categorization. In some cases, categorizations may allow processor 108 to make calculations and determinations of elements within processor 108 data. In some cases, each categorization may contain its own unique calculations wherein processor 108 may be configured to make determinations and calculations based on each response.

With continued reference to FIG. 1, data set 120 and/or product data set may be received by processor 108 through user input. For example, a user associated with a product or data set 120 may be tasked with inputting product data ser. A “user” for the purposes of this disclosure is an individual that is associated with a product described in data set 120. For example, a user may include an individual seeking to manufacture a particular item, an individual associated with an entity seeking to manufacture the item and any other individuals that may be associated with the product. In some cases, data set 120 may be received by one or more individuals associated with the entity. For example, elements of data set 120 may be received by one individual whereas other elements of data set 120 may be received by another individual. In some cases, data set 120 may be received from third party sources such as a database 116 belonging to the entity, a software containing information associated with the entity and the like. In some cases, a user may input a digital spreadsheet wherein the digital spreadsheet may contain multiple cells wherein each cell may include a datum or element of data set 120. In some cases, processor 108 may be configured to receive a template, wherein the template may include predefined section in which a user may input data. For example, a first section may be configured to receive a particular element of data set 120 wherein a second section may be configured to receive a second element of data set 120. In some cases, processor 108 may be configured to receive data set 120 through a user interface wherein the user interface is configured to display requests and receive inputs associated with the requests. For example, the user interface may display a request to receive a name of the product, wherein receipt of the name may be input into data set 120. In some cases, processor 108 may be configured to ask one or more questions through a user interface wherein a response to the one or more questions may be received as elements of data set 120. In some cases, a user may be tasked with inputting elements into a digital form, wherein the digital form may contain information and/or instructions instructing the user on what information may be required and/or where a particular information may be inputted within the digital form. In some cases, receiving data set 120 may include receiving one or more documents and/or files from a user.

With continued reference to FIG. 1, data set 120 and/or product data set may include data from files or documents that have been converted in machine-encoded test using an optical character reader (OCR). For example, a user may input digital forms and/or scanned physical documents that have been converted to digital documents, wherein product data ser may include data that has been converted into machine readable text. In some embodiments, optical character recognition or optical character reader (OCR) includes automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from the background of the image component. In some cases, binarization may be required for example if an employed OCR algorithm only works on binary images. In some cases, a line removal process may include the removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process will include an OCR algorithm. Exemplary OCR algorithms include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

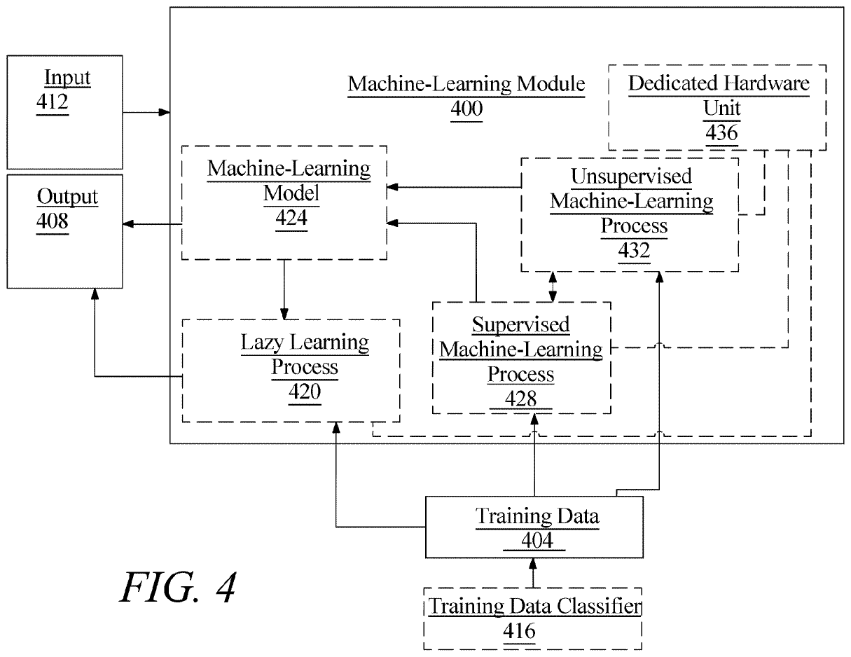

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 4-6. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

Still referring to FIG. 1, in some cases, OCR may employ a two-pass approach to character recognition. The second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 4, 5, and 6.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, processor 108 may be configured to receive data set 120 and/or product data set from database 116. In some cases, a user may input data set 120 from a separate computing system, wherein the data set 120 is transmitted to database 116. In an embodiment, processor 108 may be configured to data set 120 from database 116 for processing.

With continued reference to FIG. 1, processor 108 is configured to categorize data set 120 into a descriptor categorization 124. “Descriptor categorization,” for the purposes of this disclosure, is a grouping of data sets 120 wherein each grouping may be associated with a particular validation process. In some cases, descriptor categorizations 124 may include categorizations such as algorithms, individuals, medical, food, images, videos, and the like. In an embodiment, each descriptor categorization 124 may be associated with a particular validation process. In one or more embodiments, two distinct data sets may require different validation processes. For example, a first data set 120 containing information about an individual may require a validation process ensuring that the information about the individual is correct and valid, whereas a dataset 120 containing information about an image may require a validation process ensuring that the metadata of the image is correct and valid. In some cases, a particular validation process may ensure that all the necessary data required for processing is present within data set 120. In some cases, a plurality of validation processes may exist wherein a particular validation process may be chosen for a particular data set 120. In some cases, descriptor categorizations may allow for categorizations of data sets 120 prior to processing. In some cases, descriptor categorizations 124 may allow for the use of machine learning models wherein only correlated inputs and outputs belonging to the same categorization may be used. In an embodiment, descriptor categorization may be used to ensure that outputs of the machine learning model are more accurate as they belong to the same class. In an embodiment, descriptor categorizations may be used to update one or more machine learning models wherein inputs and correlated outputs belong to a particular descriptor categorization 124. In some cases, descriptor categorizations may include a production categorization. “Production categorization” for the purposes of this disclosure is a grouping of data sets, wherein each grouping is related to a particular industry. In a non-limiting example, a chair may be grouped with a furniture categorization, a vehicle may be grouped with an automotive categorization, and the like. In an embodiment, a production categorization may be assigned to a particular product to a particular industry. For example, an edible item may be categorized to a food and beverage industry. production categorization may include categorizations such as, but not limited to, automotive, electronic, food and beverage, medical devices, energy, smart phones, computing devices 104, children's toys, books, toys, games, furniture, cooking utensils, vitamins, kitchen appliances, household appliances, electrical products, and the like. In some cases, product data set 120 may be categorized into more than one production categorizations. For example, a children's toy having electrical components may be categorized into the children's production categorization and the electronics categorization. In another non limiting example, a medical device having electronic components may be categorized into the medical device categorization and the electronics categorization. In an embodiment, production categorization may be used to categorize a particular product to a particular industry. In an embodiment, production categorization may be make determinations about a particular product based on the industry it is categorized to.

With continued reference to FIG. 1, processor 108 may be configured to categorize data set 120 as a function of user input 128. In an embodiment, processor 108 may be configured to receive one or more descriptor categorizations 124 from a user. In an embodiment, processor 108 may be configured to visually present through a user interface (described further below), one or more descriptor categorizations 124 wherein a user may select through the user interface any particular descriptor categorizations 124 that may be associated with data set 120. In an embodiment, a user may be prompted by processor 108 to input one or more keywords, wherein processor 108 may be configured to select a descriptor categorization 124 as a function of the key words. “Keyword” for the purposes of this disclosure is a word that is informative of a particular set of information, such as data set 120. For example, a keyword of ‘battery’ may be informative that data set 120 contains batteries and likely electronic components as a result. In some cases, one or more keywords may be retrieved from a database wherein processor 108 may receive one or more keywords to categorize the data set 120. Processor 108 may use a lookup table to lookup each input keyword and find an associated descriptor categorization 124 to the key word. For example, a user may input ‘battery’ wherein processor 108 may look up a corresponding descriptor categorization 124 associated with battery. In some cases, a particular keyword may be associated with one or more descriptor categorizations 124. In some cases, a user may input multiple keywords wherein each keyword may be associated with a particular descriptor categorization 124. In an embodiment, processor 108 may receive one or more keywords and using a lookup table categorize the data set 120 to one or more descriptor categorization 124. A “lookup table,” for the purposes of this disclosure, is a data structure, such as without limitation an array of data, that maps input values to output values. A lookup table may be used to replace a runtime computation with an indexing operation or the like, such as an array indexing operation. A look-up table may be configured to pre-calculate and store data in static program storage, calculated as part of a program's initialization phase or even stored in hardware in application-specific platforms. Data within the lookup table may include elements of data set 120 and/or keywords associated with one or more descriptor categorizations 124. Data within the lookup table may be received from database 116. Data within the lookup table may further be populated by a 3^{rd} party, such as an individual associated with manufacturing, an individual associated with maintaining apparatus 100 and the like. In some cases, processor 108 may be configured to receive one or more keywords and lookup a particular descriptor categorization 124. In some cases, processor 108 may receive a plurality of keywords from a database wherein one or more keywords may be associated to one or more descriptor categorizations 124. In some cases processor 108 may visually present one or more keywords to a user to select. This may include selection through a user interface such as selection from a drop-down list, selection of one or more clickable elements containing a keyword, searching for one or more keywords and the like. In some cases, processor 108 may be configured to parse through data set 120 and select element within data set 120 that are correlated to a keyword. For example, an element in data set 120 may contain the word “battery” wherein processor 108 may be configured to categorize data set 120 to a battery descriptor categorization 124. Similarly, an element within data set 120 may contain information such as “chair” wherein processor 108 may lookup chair and determine that the data set 120 should be categorized to a furniture descriptor categorization 124. In some cases, processor 108 may be configured to determine the presence of one or more keywords within data set 120 wherein the presence of a particular keyword may be indicative of a particular descriptor categorization 124. In some cases, processor 108 may receive a plurality of keywords associated to a plurality of descriptor categorizations 124 form a database 116 and determine the presence of one or more keywords within data set 120.

With continued reference to FIG. 1, processor 108 may further be configured to categorize data set 120 by classifying data set 120 using a descriptor classifier 132. In embodiment, processor 108 may be configured to classify data set 120 to one or more descriptor categorizations 124.

With continued reference to FIG. 1, a “classifier,” as used in this disclosure is a machine-learning model, such as a mathematical model, neural net, or program generated by a machine learning algorithm known as a “classification algorithm,” as described in further detail below, that sorts inputs into categories or bins of data, outputting the categories or bins of data and/or labels associated therewith. Classifiers as described throughout this disclosure may be configured to output at least a datum that labels or otherwise identifies a set of data that are clustered together, found to be close under a distance metric as described below, or the like. In some cases, processor 108 may generate and train a descriptor classifier 132 configured to receive data set 120 and output one or more descriptor categorizations 124. Processor 108 and/or another device may generate a classifier using a classification algorithm, defined as a process whereby a computing device 104 derives a classifier from training data. In some cases descriptor classifier 132 may classify data set 120 and/or elements thereof to one or more descriptor categorizations 124. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. A descriptor classifier 132 may be trained with training data correlating elements of data set 120 to descriptor categorizations 124. In an embodiment, training data may be used to show that a data set 120 and/or elements thereof may be correlated to a particular descriptor categorization 124. Training data may be received from an external computing device 104, user input 128, and/or previous iterations of processing. A descriptor classifier 132 may be configured to receive as input and categorize components of data set 120 to one or more descriptor categorizations 124. In some cases, processor 108 and/or computing device 104 may then select any elements data set 120 containing a similar label and/or grouping and group them together. In some cases, data set 120 may be classified using a classifier machine learning model. In some cases classifier machine learning model may be trained using training data correlating a plurality of data sets 120 and/or elements thereof to a plurality of descriptor categorizations 124. In an embodiment, a particular element within data set 120 may be correlated to a particular descriptor categorization 124. In some cases, classifying data set 120 may include classifying data set 120 as a function of the classifier machine learning model. In some cases classifier training data may be generated through user input 128. In some cases, classifier machine learning model may be trained through user feedback wherein a user may indicate whether a particular element corresponds to a particular descriptor categorization 124. In some cases, classifier machine learning model may be trained using inputs and outputs based on previous iterations. In some cases, a user may input previous data set 120 and corresponding descriptor categorizations 124 wherein classifier machine learning model may be trained based on the input.

With continued reference to FIG. 1, computing device 104 and/or processor 108 may be configured to generate classifiers as described throughout this disclosure using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database 116, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process for the purposes of this disclosure. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors for the purposes of this disclosure, may be scaled, such that each vector represents each attribute along an equivalent scale of values. Each vector may be “normalized,” or divided by a “length” attribute, such as a length attribute [symbol] as derived using a Pythagorean norm:

$$l = \sqrt{{\sum }_{i = 0}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With continued reference to FIG. 1, processor 108 may further be configured to select one or more descriptor categorizations 124 based on the classification. For example, processor 108 may select a particular production classification such as automotive, when elements of data set 120 are classified to an automotive grouping. In some cases, processor 108 may select one or more descriptor categorizations 124 for further processing. In some cases, processor 108 elements of data set 120 may be classified to one or more descriptor categorization 124 wherein processor 108 may be configured to select only a predetermined amount of descriptor categorization 124. In an embodiment, processor 108 may select only those descriptor categorizations 124 that have been classified to a predetermined number of elements within data set 120. In another embodiment, processor 108 may select only those descriptor categorizations 124 that contained the most classified elements, such as the top four descriptor categorizations 124 that contained the most classified elements. In some cases, processor 108 may select any descriptor categorization 124 that an element within data set 120 has been classified to. In some cases, only particular elements within data set 120 may be classified to a particular descriptor categorization 124. For example, an element describing a name of an individual or a name of an entity may not be classified to any descriptor categorization 124.

With continued reference to FIG. 1, processor 108 is further configured to compare the data set 120 to one or more validity thresholds 136 as a function of at least one descriptor categorization 124. “Validity threshold” for the purposes of this disclosures is a one or more thresholds that may indicate a particular data set 120 is suitable for processing. In some cases, validity threshold 136 may include one or more thresholds to determine whether a particular element within data set 120 is present. This may include an element that is necessary for processing. For example, a particular data set 120 containing an image may require that the image contain the light intensity within the image. In some cases one or more validity thresholds may include one or more quality assurance thresholds. “Quality assurance threshold,” for the purposes of this disclosure, is one or more thresholds that may indicate whether a particular product meets consumer, manufacturing or governmental standards. For example, quality assurance threshold may include a warning threshold wherein the absence of warning within data set 120 or the absence of a particular warning may indicate that the product within data set 120 has not met a particular quality safety threshold. Similarly, the absence of one or more elements within data set 120 (such as, for example, dimensions) may indicate that the data set 120 did not meet a particular threshold. In an embodiment, validity threshold 136 may be used to ensure that all the necessary information required to manufacture a product is present within data set 120. In an embodiment, validity threshold 136 may be further be used to ensure that all elements within data set 120 meet consumer, manufacturing and/or governmental standards. In some cases, validity threshold 136 may be used to ensure that one or more elements meet or exceed a particular standard. In some cases, validity threshold 136 may include thresholds such as minimum size requirements, requirements for particular materials, requirements to contain one or more instructions, and the like. In some cases, validity threshold 136 may be used to determine the presence of one or more elements within data set 120. This may include but is not limited to visual preferences associated with the product (e.g. images, 3D models, etc.), pricing associated with the product, delivery requirements, packaging requirements, relevant industry specifications based on descriptor categorization 124, communication preferences, design capabilities and the like.

With continued reference to FIG. 1, each validity threshold 136 may be associated with a descriptor categorization 124. For example, a validity threshold 136 determining whether a particular material contains lead may be associated with a children's descriptor categorization 124 wherein a children's product containing lead may not meet consumer standards. Similarly, a validity threshold 136 determining the presence of battery warnings may be associated with an electronics categorization wherein the absence of a battery warning on a product may not meet consumer standards. In some cases, a particular validity threshold 136 may be associated with one or more descriptor categorizations 124. For example, a particular validity threshold 136 that includes determining the presence of a visual representation of a product may be associated with any and/or all descriptor categorizations 124. Similarly, particular validity threshold 136 used to determine a shipping address, a shipping name, payment information and the like may be associated with any and/or all descriptor categorization 124.

With continued reference to FIG. 1, validity thresholds 136 may be generated by an operator of apparatus 100, a 3^{rd} party such as a manufacturer, an entity associated with apparatus 100, and the like. In some cases, an operator of apparatus 100 may be configured to generate one or more validity thresholds 136 and categorize them to one or more descriptor categorizations 124. In some cases, processor 108 may receive one or more files, such as governmental forms used to sell or distribute products and parse through the forms to generate one or more validity threshold 136.

With continued reference to FIG. 1, each validity threshold 136 may be associated with a particular descriptor categorization 124. In an embodiment, processor 108 may receive one or more descriptor categorizations 124 and select one or more validity thresholds 136 associated with the descriptor categorizations 124. In some cases, processor 108 may look up a particular descriptor categorization 124 and receive one or more validity thresholds 136 from a lookup table. In some cases, one or more validity thresholds 136 may be generated using a WebCrawler. A “web crawler,” as used herein, is a program that systematically browses the internet for the purpose of Web indexing. The web crawler 140 may be seeded with platform URLs, wherein the crawler may then visit the next related, retrieve the content, index the content, and/or measures the relevance of the content to the topic of interest. In some embodiments, computing device 104 may generate a web crawler 140 to compile one or more validity thresholds 136. The web crawler 140 may be seeded and/or trained with websites, such as governmental sites associated with selling or distributing products, regulatory body websites, industry trade groups, and the like to begin the search. This may include, but is not limited to, government websites relating to the regulation of edible items, government websites relating to medical devices, and the like. In some cases, the web crawler 140 may be configured to receive one or more requirements from one or more manufacturing and distributing websites. For example, a particular website containing instruction on the particular information needed to be produce a product may be used as one or more validity thresholds 136. A web crawler 140 may be generated by computing device 104. In some embodiments, the web crawler 140 may be trained with information received from a user through a user interface. In some embodiments, the web crawler 140 may be configured to generate a web query. A web query may include search criteria received from a user. For example, a user may submit a plurality of websites for the web crawler 140 to search to extract any data suitable for system data.

With continued reference to FIG. 1, one or more validity thresholds 136 may be generated by one or more end users 144. An “end user” for the purposes of this disclosure is a potential individual or entity that may receive data set 120 or elements thereof. End user 144 may include a manufacturer, a production manager, an entity capable of producing and/or distributing one or more products and the like. In some cases, each end user 144 may input one or more validity thresholds 136. In some cases, each end user 144 may be associated with one or more descriptor categorizations 124 wherein each end user 144 may input associated validity thresholds 136 to the one or more descriptor categorizations 124. For example, a particular end user 144 may input thresholds that need to be met or exceeded in order for a particular product to be produced or manufactured. In some cases, one or more end users 144 may input validity thresholds 136 and their corresponding descriptor categorization 124. In an embodiment, processor 108 may receive the descriptor categorizations 124 associated with data set 120 and output validity thresholds 136 associated with a particular descriptor categorization 124.

With continued reference to FIG. 1, processor 108 may be configured to compare data set 120 to one or more validity thresholds 136 as a function of at least one descriptor categorization 124. In some cases, processor 108 may receive one or more validity thresholds 136 as a function of the one or more descriptor categorizations 124 as described above. In some cases, data set 120 and/or elements therefore may be compared to one or more validity thresholds 136. In some cases, processor 108 may determine the presence of one or more elements within data set 120 based on the one or more validity thresholds 136. In some cases, processor 108 may make one or more calculations using an arithmetic logic unit within computing device 104. In some cases, processor 108 may make one or more calculations using elements of data set 120 and compare the calculations to one or more validity thresholds 136. For example, processor 108 may be configured to determine the volume of a particular product using the length, width and height. In some cases, processor 108 may be configured to determine whether elements within data set 120 meet or exceed a particular validity threshold 136. For example, processor 108 may determine that a particular product is too small based on the validity threshold 136 wherein the product may be utilized by younger children. In some cases, processor 108 may determine the presence of particular elements within data set 120, wherein the presence of an element may indicate that the data set 120 does not meet a particular threshold. For example, a particular product containing lead may not meet a particular threshold when the product is associated with children's toys. In another non-limiting example, a product containing hazardous substances (e.g. ammonia) may not meet a particular validity threshold 136 such as one associated with a food categorization. In some cases, validity threshold 136 may be used to ensure that all essential and individualized product criteria are met for a particular product within data set 120. In some cases, validity threshold 136 may be used to determine that a particular product conforms to industry standards. This may include determinations based on size, dimensions, materials, costs, location of manufacture, whether testing is required, and the like. In some cases, validity thresholds 136 may include any governmental or industry standards. In some cases, one or more validity thresholds 136 may be used as a checklist to ensure that a product meets one or more standards.

With continued reference to FIG. 1, processor 108 is further configured to generate one or more data modules 148. A data module for the purposes of this disclosure is improvements and/or modifications of a particular data set. For example, a particular data set that contained one or more missing elements may be added within data module. In one or more embodiments, a particular data module may include a data set that has been compared to one or more validity thresholds 136. In an embodiment, data module may include dataset and any missing or incorrect information as indicated by the one or more Validity thresholds 136. In some cases, data set may include data set and/or any other information that may be necessary for configuration as described below. In some cases, data module may include a product data module 148. A “product data module” for the purposes of this disclosure is information relating to improvements or production of a product associated with data set 120 and/or product data set. For example, a particular product data module may include one or more elements within product data set hat has not met or exceeded a particular validity threshold 136 such as one or more quality assurance thresholds. In an embodiment, the product data module may be used to ensure that a product conforms to industry and/or government standards. In another non limiting example, a particular product data module may include information on manufacturing or product a product within data set 120. This information may include but is not limited to, contact information of a manufacturer who is capable of manufacturing the product, costs associated with manufacturing, estimated time it may take to manufacture, estimated time of delivery and the like. In some cases, data modules 148 may include information such as ideal standards, ideal specification and/or ideal information within a particular industry based the one or more elements within data set 120 that fail to meet one or more validity thresholds 136. For example, data module 148 may contain formation about an ideal size requirement or a minimum size requirement when a particular product fails to meet the minimum size requirements when compared to the one or more validity thresholds 136. Similarly, data module 148 may contain information indicating that a particular product cannot contain a particular material (e.g. lead) when the validity threshold 136 indicates so. In some cases generating one or more data modules 148 include selecting the one or more validity thresholds 136 that have not been met or exceeded. For example, a particular validity threshold 136 may be selected when a particular product's dimensions do not meet the validity threshold 136. The data module 148 may include the validity threshold 136 wherein the validity threshold 136 may be used as an ideal industry standard. In some cases, data module 148 may be used to indicate to a user that a particular product does not conform to one or more requirements based on its assigned descriptor categorizations 124. In some cases, a particular data module 148 may indicate to a user potential improvements or additions that will make the product within data set 120 conform to one or more standards. In some cases, each validity threshold 136 may be associated with one or more instructions, wherein a particular set of instructions may be selected based on a failure to meet or exceed one or more validity standards. In some cases, each validity threshold 136 may contain a correlated set of instructions, wherein processor 108 may receive the instructions by using a lookup table. In an embodiment, processor 108 may look up one or more validity thresholds 136 on the lookup table and retrieve one or more instruction sets associated with the one or more validity thresholds 136. In some cases, an operator, manufacturer and/or the like may populate the lookup table. In some cases, the lookup table may be located on database 116 wherein one or more instructions are received from database 116. In some cases, processor may use a machine learning model such as any machine learning model as described in this disclosure to determine whether a particular validity threshold has been met. In some cases, training data having a plurality of data sets 120 correlated to a plurality of validity thresholds may be used to train the machine learning model. In an embodiment, a particular data set 120 may be correlated to a particular validity threshold 136. In an embodiment, training data may be inputted by a user, retrieved from a database and/or retrieved in any way as described in this disclosure. In some cases processor 108 may generate one or more validity thresholds 136 as a function of the machine learning model. Additionally or alternatively, processor may make one or more determinations about whether a particular data set has exceeded a particular validity threshold 136.

With continued reference to FIG. 1, data modules 148 may further include information relating to one or more end users 144 (as described above). This may include but is not limited to, manufacturing costs for a product associated with data set 120, manufacturing time, the end user's product quality, the end user's location of manufacturing and/or any other information necessary to produce or manufacture a product. In some cases, one or more data modules 148 may include one or more transport configurations 152. “Transport configuration” for the purposes of this disclosure is information indicating a potential mode of transport for the product described within data module 148 and any other information associated with the transport. For example, transport configuration 152 may include information that a potential method of transport is by freight trunk and delivery may take 14 business days. Transport configuration 152 may include, but is not limited to, the mode of transport (e.g. truck, boat, plane, etc.), the duration until the product is delivered (e.g. 2, days, 4 days, etc.), the amount of products that may delivered on one container, the amount of product that can be delivered (e.g. 200 units may be delivered at once), the amount of products that may be delivered per unit of time (e.g. 200 units delivered per month), costs associated with the transport, such as delivery costs and the like. In some cases, data module 148 may further include manufacturing costs, costs of materials. time it may take to manufacture a product, and the like. With continued reference to FIG. 1, transport configuration 152 may be generated based on the size and weight of the product. For example, a particular product having a particular size and weight may be able to be placed on an aircraft, within a particular shipping container and the like. In another non limiting example, the size and weight may determine how many products may be transported on a single truck, within a single shipping container, on a single aircraft and the like. In some cases, the materials within data set 120 may indicate a particular mode of transportation. For example, hazardous material may be placed on a more secure vehicle such a train, or a more secure truck. In some cases, transport configuration 152 may be unique to each end user 144. For example, an end user 144 located within a particular geographic region may take longer to deliver a product than another end user 144. Similarly, an end user 144 located on a differing continent as the user may be constrained to only boats and planes as method of transport. In some cases, each end user 144 may contain one or more transport configurations 152 wherein selection of a particular end user 144 may indicate a particular transport configuration 152. In some cases, each end user 144 may be associated with one or more calculations and/or algorithms wherein elements within data set 120 may be used to determine a particular transport configuration 152 based on calculations. For example, processor 108 may determine a distance between a user and an end user 144 as determine a particular transport configuration 152 including the mode of transport, the cost and the date of delivery. In some cases, the calculations may include calculations a particular price per mile, a particular time frame per mile and the like. In some cases, calculation made be based on the mode of transport wherein a plane may contain a higher cost per mile but a lower delivery time whereas a boat may contain a lower cost per mile but a higher delivery time. In some cases, calculation may be based on ranges wherein a range of 1-100 miles for example, a contain a particular price and a particular time for delivery. In some cases, each end user 144 may contain their own calculations and/or pricing wherein the pricing may be calculated as a function of data set 120. In some cases, each end user 144 may contain an associated table of transportation configuration 152 wherein a user may view the table and determine an ideal transport configuration 152. For example, a user may receive a table from an end user 144 wherein the table contains information such as modes of transport and their associated costs per mile, and estimated manufacturing times. In some cases, each end user 144 may have an associated lookup table wherein each lookup table may be used to determine a particular transport configuration 152 based on the presence of an element within data set 120. For example, a user may indicate within data set 120 their preferred transportation configuration 152 wherein the preferred transportation configuration 152 may be looked up and correlated prices, shipping times and the like may be retrieved.

With continued reference to FIG. 1, in some cases, one or more data modules 148 may include an associated quantitative element 156. A “quantitative element” is information associated with the calculated pricing of one or more products within data set 120. For example, quantitative element 156 may include the cost to manufacture a particular product. Quantitative element 156 may further include the costs to transport a product. In some cases, quantitative element 156 may include a total cost to manufacture, produce and transport a product suitable to be sold to consumers and a breakdown of all the costs. The breakdown of costs may include cost of manufacture, cost to transport, cost for packaging and the like. In some cases, each data module 148 may include a quantitative element 156 associated with a particular end user 144. For example, a first data module 148 may include a quantitative element 156 associated with a first end user 144 and a second data module 148 may include a quantitative element 156 associated with a second end user 144. In some cases, the first data module 148 may include a differing quantitative element 156 as the second data module 148. In some cases, quantitative element 156 may be generated based on the material required for the product as indicated within data set 120 and the amount of material required for each product. For example, a particular end user 144 may charge 1.00$ per gram of steel, 50 cents per gram of plastic and the like wherein processor 108 may calculate quantitative element 156 based on the amount of steel or plastic required. In some cases, each material and/or component of a product within data set 120 may contain a correlated manufacturing cost. In some cases, processor 108 may receive the bill of materials within data set 120 and calculate an associated quantitative element 156 as a function of the bill of materials. For example, processor 108 may use a lookup table to lookup various costs associated with each material and/or component and determine an overall quantitative element 156 based on each of the individual costs. For example, processor 108 may use a lookup table to determine the cost of a plastic per amount and calculate the cost of the plastic for the amount mentioned with the bill of materials. In some cases, processor 108 may use a lookup table to lookup each material and/or component within the bill of materials and calculate a quantitative element 156 that may be used to determine the price of the product. In some cases, the price of each product may vary wherein a particular amount of products purchased and/or manufactured may reduce the cost of each product. For example, processor 108 may make calculations for a particular range of products wherein 1-100 products may be one particular price, 101-200 products may give a 5% discount on the overall cost of each product and the like. In some cases, each lookup table may be associated with each particular end user 144, wherein a particular end user 144 may contain their own costs associated with each material and/or component.

With continued reference to FIG. 1, one or more data modules 148 may be associated with one or more end users 144. In some cases each data module 148 may include quantitative elements 156, transportation configuration s 152 and any other data associated with a particular end user 144. In some cases, data module 148 may further include a “rating” of the end user 144. Rating for the purposes of this disclosure is a label associated with an end user 144 that is indicative of an end user's manufacturing and production capabilities. In some cases, rating may include a numerical rating from 1-5 wherein a 1 may indicate that the end user 144 has poor manufacturing and production capabilities and a 5 may indicate that the end user 144 has excellent manufacturing capabilities. In some cases, an end user 144 may contain a plurality of ratings wherein each rating may be associated with a different aspect of production and/or manufacturing. For example, a first rating may be associated with quality of a manufactured product whereas a second rating may be associated with the end user's communicative skills. In some cases, the plurality of ratings may include product quality, communication, delivery times, pricing, reliability, and the like. In some cases, ratings may include how environmentally friendly a particular end user 144 is. This rating may be graded based on the manufacturer's overall carbon emissions and/or based on the end user's carbon emissions per product or per specified unit. In some cases, a higher environmental rating may be associated with lower carbon emissions and a low rating may be associated with higher carbon emissions. In some cases, data module 148 may include a user rating 160. “User rating” for the purposes of this disclosure is a rating generated by previous clientele. For example, an individual who previously used this particular end user 144 for production of a product may give the end user 144 a particular rating. In some cases, end user 144 may include an average rating wherein the average rating is an average of all users who gave a rating. In some cases, user rating 160 may be weighted wherein a particular user's vote or rating may be given a lighter or heavier weighting within the average. This weighting may be based on the user's status, a particular number of products the user purchased and the like. In some cases, data module 148 may further include any contact information about an end user 144 and/or any information that may be necessary to decide about a particular end user 144.

With continued reference to FIG. 1, processor 108 may be configured to retrieve a plurality of end users 144 in order to generate one or more data modules 148. In some cases, the plurality of end users 144 may be retrieved from database 116. In an embodiment, each of the plurality of end users 144 may be a particular manufacturer, producer, or distributor. In some cases, each end user 144 may be associated with a particular descriptor categorization 124. For example, a first end user 144 may be associated with an electronics categorization wherein the end user 144 may hold themselves out as being capable of distributing, manufacturing and/or producing electronic products. In some cases, processor 108 may receive as an input information relating to one or more end users 144 from the one or more end users 144. In an embodiment, one or more end users 144 may input their own information and their associated descriptor categorizations 124, wherein an associated descriptor categorization 124 may indicate the type of product the end user 144 can manufacture or produce. In some cases, each end user 144 may input one or more descriptor categorizations 124 wherein input of each descriptor categorization 124 may signify that the end user 144 is capable of manufacturing or producing a product within the particular grouping. In some cases, processor 108 may receive a plurality of end users 144 using a web crawler 140, through user input 128 and the like. In some cases, processor 108 may plurality of end users 144 may be located and retrieved from a database 116. In some cases, apparatus 100 may be configured to receive one or more end users 144 wherein an operator may determine if the end users 144 are suitable for manufacturing and/or production.

With continued reference to FIG. 1, generating one or more data modules 148 may include using a data module machine learning model 164. Processor 108 may use a machine learning module, such as data module machine learning module for the purposes of this disclosure, to implement one or more algorithms or generate one or more machine-learning models, such as a data module machine learning model 164, to generate one or more data modules 148. However, the machine learning module is exemplary and may not be necessary to generate one or more machine learning models and perform any machine learning described herein. In one or more embodiments, one or more machine-learning models may be generated using training data. Training data may include inputs and corresponding predetermined outputs so that a machine-learning model may use correlations between the provided exemplary inputs and outputs to develop an algorithm and/or relationship that then allows machine-learning model to determine its own outputs for inputs. Training data may contain correlations that a machine-learning process may use to model relationships between two or more categories of data elements. Exemplary inputs and outputs may come from database 116, such as any database 116 described in this disclosure, or be provided by a user. In other embodiments, a machine-learning module may obtain a training set by querying a communicatively connected database 116 that includes past inputs and outputs. Training data may include inputs from various types of databases 116, resources, and/or user input 128s and outputs correlated to each of those inputs so that a machine-learning model may determine an output. Correlations may indicate causative and/or predictive links between data, which may be modeled as relationships, such as mathematical relationships, by machine-learning models, as described in further detail below. In one or more embodiments, training data may be formatted and/or organized by categories of data elements by, for example, associating data elements with one or more descriptor categorizations 124 corresponding to categories of data elements. As a non-limiting example, training data may include data entered in standardized forms by persons or processes, such that entry of a given data element in a given field in a form may be mapped to one or more categories. Elements in training data may be linked to categories by tags, tokens, or other data elements. A machine learning module, such as data module machine learning module, may be used to generate data module machine learning model 164 and/or any other machine learning model described herein using training data. Data module machine learning model 164 may be trained by correlated inputs and outputs of training data. Training data may be data sets that have already been converted from raw data whether manually, by machine, or any other method. Data module training data 168 may be stored in database 116. Data module training data 168 may also be retrieved from database 116. In some cases, data module training data 168 may allow for computing device 104 to compare two data items, to sort efficiently, and/or to improve the accuracy of analytical methods. In some cases, data module training data 168 may be used to improve the accuracy of generating one or more data modules 148. In some cases, training data contain classified inputs and classified outputs wherein outputs may contain a higher degree of accuracy by outputting elements with a similar classification.

With continued reference to FIG. 1, in one or more embodiments, a machine-learning module may be generated using training data. Training data may include inputs and corresponding predetermined outputs so that machine-learning module may use the correlations between the provided exemplary inputs and outputs to develop an algorithm and/or relationship that then allows machine-learning module to determine its own outputs for inputs. Training data may contain correlations that a machine-learning process may use to model relationships between two or more categories of data elements. The exemplary inputs and outputs may come from database 116, such as any database 116 described in this disclosure, or be provided by a user such as a prospective employee, and/or an employer and the like. In other embodiments, production machine-learning module may obtain a training set by querying a communicatively connected database 116 that includes past inputs and outputs. Training data may include inputs from various types of databases 116, resources, and/or user input 128s and outputs correlated to each of those inputs so that a machine-learning module may determine an output. Correlations may indicate causative and/or predictive links between data, which may be modeled as relationships, such as mathematical relationships, by machine-learning processes, as described in further detail below. In one or more embodiments, training data may be formatted and/or organized by categories of data elements by, for example, associating data elements with one or more descriptor categorizations 124 corresponding to categories of data elements. As a non-limiting example, training data may include data entered in standardized forms by persons or processes, such that entry of a given data element in a given field in a form may be mapped to one or more of categories. Elements in training data may be linked to categories by tags, tokens, or other data elements.

With continued reference to FIG. 1, generating one or more data modules 148 may include receiving data module training data 168 including a plurality of data sets 120 correlated to a plurality of data modules 148. In some cases, data module training data 168 may include a plurality of categorized data sets 120 and/or a plurality of data sets 120 compared to at least one descriptor categorizations 124 correlated to a plurality of data modules 148. In an embodiment, data module training data 168 may be used to indicate a particular data module 148. In another embodiment, data module training data 168 may indicate a particular data module 148 for a given data set 120. In some cases, data module training data 168 may be received from a user, third party, database 116, external computing devices 104, previous iterations of the processing and/or the like as described in this disclosure. In some cases, data module training data 168 may include previous iterations of data sets 120 and previous iterations of data modules 148. In some cases, data module training data 168 may be used to train data module machine learning model 164. In some cases, generating one or more data modules 148 further includes training data module machine learning model 164 as a function of the data module training data 168 and generating one or more data modules 148 as a function of the data module machine learning model 164. In some cases, data module training data 168 may be trained based on user input 128 wherein user input 128 may determine if a particular training data was accurate as a result of a previous iteration. For example, a user may indicate that a particular data module 148 containing a particular user was not a suitable match for manufacturing of the product. For example, the machine learning module may output a data module 148 associated with an end user 144 who specializes in electronics, whereas the user's product does not contain electronics. In some cases, processor 108 may be configured to receive user feedback wherein a user may indicate the error and input a correct data module 148.

With continued reference to FIG. 1, generating one or more data modules 148 may include receiving one or more data modules 148 from one or more end users 144. In an embodiment, one or more end users 144 may receive data set 120 and generate a data module 148 through user input 128. The data module 148 may include proposed costs, proposed delivery times and the like. In an embodiment, each data module 148 may act as an invoice or a proposed bid for manufacturing. In some cases, processor 108 may be configured to transmit data set 120 to one or more end users 144, wherein each end user 144 may generate a particular data module 148.

With continued reference to FIG. 1, generating one or more data modules 148 includes selecting one or more end users 144 as a function of the data set 120. In an embodiment, processor 108 may be configured to select one or more end users 144, where processor 108 may generate one or more data modules 148 as a function of the selection. In some cases, processor 108 may select one or more end users 144 based on the descriptor categorization 124. In an embodiment, processor 108 may retrieve the associated descriptor categorizations 124 of each end user 144 and select one or more end users 144 having similar descriptor categorizations 124 as data set 120. For example, processor 108 may select an end user 144 associated with a descriptor categorization 124 of furniture when data set 120 is categorized into a furniture data set. Additionally, or alternatively, an end user 144 specializing in furniture and electronics may be selected when data set 120 is categorized to both an electronics categorization and a furniture categorization. In some cases, one or more end users 144 may be associated with a plurality of descriptor categorization 124 wherein each descriptor categorization 124 may signify a particular expertise of the end user 144. In some cases, processor 108 may select only those end users 144 having at least the descriptor categorization 124 that data set 120 has been categorized to. In some cases, processor 108 may generate only data modules 148 associated with the selected end users 144. In some cases, processor 108 may further rank the data modules 148 based on each end user 144. For example, an end user 144 having a particular user rating 160 may be ranked higher than another end user 144 having a lower rating. In some cases, each end user 144 may have a rating associated with each associated descriptor categorization 124. For example, an end user 144 may have a rating of an electronics categorization fi they hold themselves out as to being associated with electronics. In some cases, the rankings may be based off of the ratings of the descriptor categorization 124. In some cases, processor 108 may further be configured to select one or more end users 144 based on geographic location or capability of producing or manufacturing a particular product. For example, a particular user may be located too far away and as a result, production and/or manufacturing may take too long. Similarly, a particular end user 144 may not be selected because they are not associated with a particular geographic location. For example, data set 120 may indicate that the product should be manufactured in the United States, wherein only end users 144 who manufacture products within the United States may be selected.

With continued reference to FIG. 1, processor 108 may further be configured to modify a graphical user interface 172 as a function of the one or more data modules 148. In some cases, processor 108 may be configured to create a user interface data structure 180. As used in this disclosure, “user interface data structure 180” is a data structure representing a specialized formatting of data on a computer configured such that the information can be effectively presented for a user interface. User interface data structure 180 may include one or more data modules 148 and any other data described in this disclosure.

With continued reference to FIG. 1, processor 108 may be configured to transmit the user interface data structure 180 to a user interface. Transmitting may include, and without limitation, transmitting using a wired or wireless connection, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. Processor 108 may transmit the data described above to database 116 wherein the data may be accessed from database 116. Processor 108 may further transmit the data above to a device display or another computing device 104.

With continued reference to FIG. 1, apparatus 100 may include a graphical user interface 172 (GUI). For the purposes of this disclosure, a “user interface” is a means by which a user and a computer system interact. For example, through the use of input devices and software. In some cases, processor 108 may be configured to modify graphical user interface 172 as a function of the one or data modules 148 by populating user interface data structure 180 with one or more data modules 148 and visually presenting the one or more data modules 148 through modification of the graphical user interface 172. A user interface may include graphical user interface 172, command line interface (CLI), menu-driven user interface, touch user interface, voice user interface (VUI), form-based user interface, any combination thereof and the like. In some embodiments, a user may interact with the user interface using a computing device 104 distinct from and communicatively connected to processor 108. For example, a smart phone, smart tablet, or laptop operated by the user and/or participant. A user interface may include one or more graphical locator and/or cursor facilities allowing a user to interact with graphical models and/or combinations thereof, for instance using a touchscreen, touchpad, mouse, keyboard, and/or other manual data entry device. A “graphical user interface,” as used herein, is a user interface that allows users to interact with electronic devices through visual representations. In some embodiments, GUI 172 may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in graphical user interface 172. Persons skilled in the art, upon reviewing the entirety of this disclosure, will be aware of various ways in which a graphical user interface 172 and/or elements thereof may be implemented and/or used as described in this disclosure.

With continued reference to FIG. 1, apparatus 100 may further include a display device communicatively connected to at least a processor 108. “Display device” for the purposes of this disclosure, is a device configured to show visual information. In some cases, display device may include a liquid crystal display (LCD), a cathode ray tube (CRT), a plasma display, a light emitting diode (LED) display, and any combinations thereof. Display device may include, but is not limited to, a smartphone, tablet, laptop, monitor, tablet, and the like. Display device may include a separate device that includes a transparent screen configured to display computer generated images and/or information. In some cases, display device may be configured to visually present one or more data through GUI 172 to a user, wherein a user may interact with the data through GUI 172. In some cases, a user may view GUI 172 through display.

With continued reference to FIG. 1, GUI 172 may be configured to visually present one or more data modules 148 to a user. In some cases, GUI 172 may visually present one or more elements of data module 148. In some cases, GUI 172 may visually present data modules 148 as clickable graphical elements wherein each graphical element is associated with a particular data module 148.

With continued reference to FIG. 1, processor 108 may be configured to receive an input of one or more data modules 148. In some cases, a user may interact with GUI 172 in order to select a particular data module 148 wherein the selection may be received as input. In some cases, Processor 108 may be configured to receive any input as described in this disclosure wherein the input may signify selection of a particular data module 148. In an embodiment, selection of a particular data module 148 through input may indicate selection of a particular end user 144. In an embodiment, a selection of a particular module may indicate that a user wishes to communicate with a particular end user 144.

With continued reference to FIG. 1, processor 108 may further be configured to generate a communication datum 176 as a function of the input. “Communication datum” for the purposes of this disclosure is information indicating that a user would like to begin communication with a particular end user 144. In some cases, communication datum 176 may include an invoice or a bid wherein the invoice contains information indicating that the user would like to manufacture one or more products. In some cases, communication datum 176 may include information that a user would like to begin a relationship with a particular end user 144. In some cases, selection, or input of a particular data module 148 may indicate the particular communication datum 176 that may be generated. For example, selection of a first data module 148 may indicate to processor 108 to generate a communication data as a function of the first data module 148. In some cases, communication datum 176 may include information about the end user 144 that is associated with first data module 148. In some cases, communication datum 176 may further include information such as information contained within data module 148. In some cases, communication datum 176 may be transmitted to end user 144, wherein the end user 144 may be given notice that a user would like to begin communication. In some cases, communication datum 176 may indicate that a user would like to engage in a business relationship with end user 144 wherein user may use end user 144 for manufacturing and production of a particular product. In some cases, processor 108 may transmit communication datum 176 to a remote device, such as a smart phone. In some cases, communication datum 176 may be transmitted in the form of a text-based message, through an image, through a digital file and the like. In some cases, communication datum 176 may be transmitted to a smartphone, laptop and the like.

With continued reference to FIG. 1, in some cases, communication datum 176 may include a particular number of products to be manufactured, a particular number of products to be shipped within a single shipping container, a particular configuration for the product described within data set to be placed within the shipping container and the like. In some cases processor 108 may make one or more determinations to generate and/or populate elements of communication datum 176. In some cases, communication datum may be generated on a recurring basis, such as for example, once a week, once a month, once a quarter and the like. In some cases, processor 108 may generate a particular communication datum 176 as a function of the one or more data module 148. In some cases, processor may receive one or more product specifications within data set 120 and determine a particular amount of products that may fit within a particular shipping container. For example, processor may be receiving the dimensions of an intermodal shipping container from a database and make one or more calculations based on the dimensions of a particular product to determine how many products may fit within a particular shipping container. In some cases, processor may make determinations about the amount of products that may fit in a shipping container by comparing the volume of the product to the volume of the shipping container. In some cases, processor 108 may compare the length, width or height of a product to the length width or height of a shipping container to determine how many products may fit within a particular direction, and correspondingly how many products may fit within a shipping container. In some cases, processor 108 may use the weight of a particular product and the maximum weight requirements within a particular container to determine the maximum products that may fit within a particular container. In some cases, processor 108 may receive a differing communication 176 wherein the differing communication datum may include products of another data set or data module. In some cases, processor 108 may determine that the differing data set may be using a particular shipping container. In some cases, processor 108 may populate the remaining space within the shipping container with the product described in data set. In some cases, processor 108 may populate a single container with multiple products associated with multiple data sets and/or data modules. In some cases, communication datum 176 may further include a sales report of the resulting shipment information of data set 120 and/or data module 148. In some cases, processor may use a machine learning model to make one or more determinations about the shipping process of one or more products within one or more data sets. In some cases, training data containing a plurality of data modules correlated to a plurality of communication datum 176 may be used to train the machine learning model. In an embodiment, a particular data module 148 and/or set of data modules 148 may indicate a particular communication datum 176. In some cases, communication datum 176 may further include a particular number of products to be ordered wherein the number may be determined based on previous iterations of the processing. For example, a previous iteration of data set 120 may indicate that a user wishes to purchase 100 products a month wherein processor may generate an updated communication datum 176 one month later indicating that a user wishes to purchase another 100 products. In some cases, a user may wish to increase production by a particular number or multiplier every month wherein processor may generate an updated communication datum 176 every month. In some cases, processor 108 may receive multiple data sets 120 and/or multiple data modules 148 and make one or more determinations relating to communication datum 176. For example, processor may determine that a particular container has enough remaining space to fit a particular product described within data set. In some cases, processor may receive from a user a particular number of products to be produced every month wherein processor may receive the number of products as indicated by data set 120 and/or data module and generate a communication datum 176 as a function of the data provided. In some cases, the communication datum may include a particular container to be shipped in, the number of products within the container and the like.

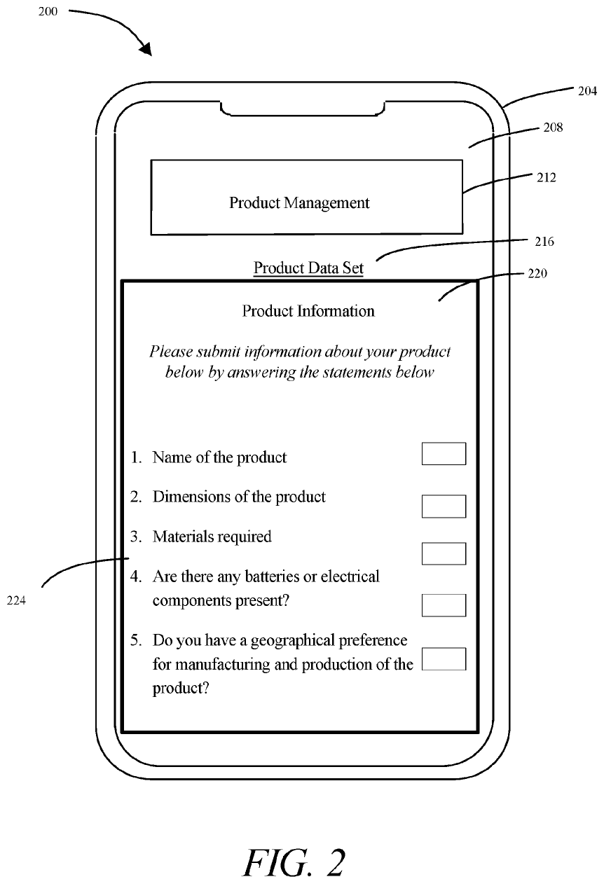

Referring now to FIG. 2, an exemplary embodiment of a GUI 200 on a display device 204 is illustrated. GUI 200 is configured to receive the user interface structure as discussed above and visually present any data described in this disclosure. Display device 204 may include, but is not limited to, a smartphone, tablet, laptop, monitor, tablet, and the like. Display device 204 may further include a separate device that includes a transparent screen configured to display computer generated images and/or information. In some cases, GUI 200 may be displayed on a plurality of display devices. In some cases, GUI 200 may display data on separate windows 208. A “window” for the purposes of this disclosure, is the information that is capable of being displayed within a border of device display. A user may navigate through different windows 208 wherein each window 208 may contain new or differing information or data. For example, a first window 208 may display information relating to data set, whereas a second window may display information relating to the data modules as described in this disclosure. A user may navigate through a first second, third and fourth window (and so on) by interacting with GUI 200. For example, a user may select a button or a box signifying a next window on GUI 200, wherein the pressing of the button may navigate a user to another window. In some cases, GUI 200 may further contain event handlers, wherein the placement of text within a textbox may signify to computing device to display another window. An “event handler” as used in this disclosure is a callback routine that operates asynchronously once an event takes place. Event handlers may include, without limitation, one or more programs to perform one or more actions based on user input, such as generating pop-up windows, submitting forms, requesting more information, and the like. For example, an event handler may be programmed to request more information or may be programmed to generate messages following a user input. User input may include clicking buttons, mouse clicks, hovering of a mouse, input using a touchscreen, keyboard clicks, an entry of characters, entry of symbols, an upload of an image, an upload of a computer file, manipulation of computer icons, and the like. For example, an event handler may be programmed to generate a notification screen following a user input wherein the notification screen notifies a user that the data was properly received. In some cases, an event handler may be used to signify to processor that an action has selection has been made. For example, a selection of a graphical icon or a particular data element through GUI may indicate to processor that a selection has been made. In some embodiments, an event handler may be programmed to request additional information after a first user input is received. In some embodiments, an event handler may be programmed to generate a pop-up notification when a user input is left blank. In some embodiments, an event handler may be programmed to generate requests based on the user input. In this instance, an event handler may be used to navigate a user through various windows 208 wherein each window 208 may request or display information to or from a user. In this instance, window 208 displays an identification field 212 wherein the identification field signifies to a user, the particular action/computing that will be performed by a computing device. In this instance identification field 212 contains information stating “Supply Chain Management” wherein a user may be put on notice that any information being received or displayed will be used for supply chain management. This may be done through the receipt of data set or alternatively product data set, the generation of one or more data modules and/or the selection of one or more data modules as described in this disclosure. Identification field 212 may be consistent throughout multiple windows 208. Additionally, in this instance, window 208 may display a sub identification field 216 wherein the sub identification field may indicate to a user the type of data that is being displayed or the type of data that is being received. In this instance, sub identification field 216 contains “Product data set”. This may indicate to a user that computing device is currently collecting information relating to one or more products. Additionally, window 208 may contain a prompt 220 indicating the data that is being described in sub identification field 216 wherein prompt 220 is configured to display to a user the data that is currently being received and/or generated. In this instance, prompt 220 notifies a user that information for product data set is currently being collected in the current window 208. In this instance GUI 200 may contain questions or statements along with input boxes wherein input into the input boxes may indicate to computing device the receipt of information. In this instance, product data set may be received through one or more questions or statements displayed on the device.

With continued reference to FIG. 2, GUI 200 may be configured to receive user feedback. For example, GUI may be configured to generate one or more outlier modules wherein a user may interact with GUI 200 and provide feedback on the generated data modules. In some cases, a user may desire to view multiple outlier modules wherein a user may navigate back and forth through various windows to select one or more outlier modules and view any corresponding information associated with the outlier modules. In some cases, user feedback may be used to train a machine learning model as described above. In some cases, user feedback may be used to indicate computing device to generate alternative data modules.

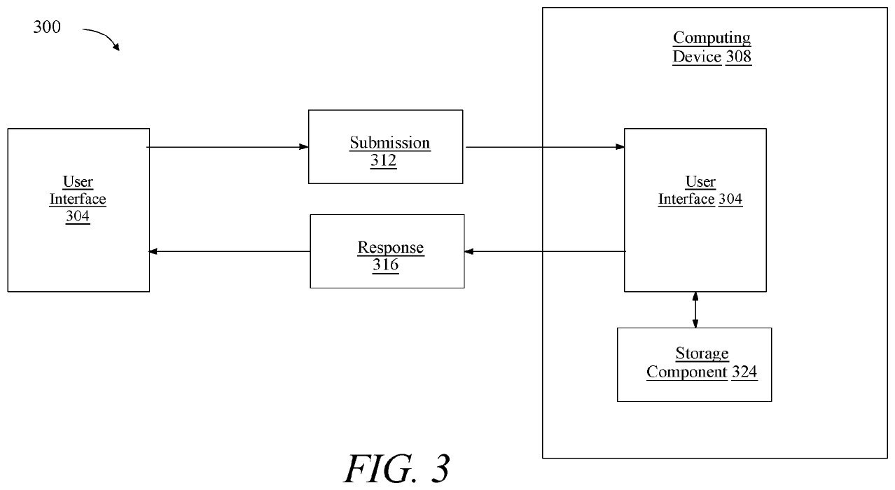

Referring to FIG. 3, a chatbot system 300 is schematically illustrated. According to some embodiments, a user interface 304 may be communicative with a computing device 308 that is configured to operate a chatbot. In some cases, user interface 304 may be local to computing device 308. Alternatively or additionally, in some cases, user interface 304 may remote to computing device 308 and communicative with the computing device 308, by way of one or more networks, such as without limitation the internet. Alternatively or additionally, user interface 304 may communicate with user device 308 using telephonic devices and networks, such as without limitation fax machines, short message service (SMS), or multimedia message service (MMS). Commonly, user interface 304 communicates with computing device 308 using text-based communication, for example without limitation using a character encoding protocol, such as American Standard for Information Interchange (ASCII). Typically, a user interface 304 conversationally interfaces a chatbot, by way of at least a submission 312, from the user interface 308 to the chatbot, and a response 316, from the chatbot to the user interface 304. In many cases, one or both of submission 312 and response 316 are text-based communication. Alternatively or additionally, in some cases, one or both of submission 312 and response 316 are audio-based communication.

Continuing in reference to FIG. 3, a submission 312 once received by computing device 308 operating a chatbot, may be processed by a processor 320. In some embodiments, processor 320 processes a submission 3112 using one or more keyword recognition, pattern matching, and natural language processing. In some embodiments, processor employs real-time learning with evolutionary algorithms. In some cases, processor 320 may retrieve a pre-prepared response from at least a storage component 324, based upon submission 312. Alternatively or additionally, in some embodiments, processor 320 communicates a response 316 without first receiving a submission 312, thereby initiating conversation. In some cases, processor 320 communicates an inquiry to user interface 304; and the processor is configured to process an answer to the inquiry in a following submission 312 from the user interface 304. In some cases, an answer to an inquiry present within a submission 312 from a user device 304 may be used by computing device 104 as an input to another function, for example without limitation at least a feature 108 or at least a preference input 112.

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm instantiated in hardware or software logic, data structures, and/or functions that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure. As a non-limiting illustrative input data such as data set may be correlated to output data such as data module.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 416 may classify elements of training data to one or more categorization such as one or more descriptor categorizations. In an embodiment, classification may allow for reduction in errors. In an embodiment, classification may allow for training of the machine learning model wherein classified inputs may be correlated to similarly classified outputs. In some cases, the machine learning model may be trained wherein only similarly classified items may be correlated. In some cases, classification may allow for supervised learning wherein labeled data has correlated and known outcomes. In some cases, classification may allow for organization and efficiency in the machine learning model wherein inputs and outputs are categorized based on classification.

With further reference to FIG. 4, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 4, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may identified as having poor quality data, where “poor quality” is defined as having a signal to noise ratio below a threshold value.

As a non-limiting example, and with further reference to FIG. 4, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 4, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units

In some embodiments, and with continued reference to FIG. 4, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include inputs as described above as inputs, outputs as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

With further reference to FIG. 4, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 4, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 4, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 4, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 4, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 4, one or more processes or algorithms described above may be performed by at least a dedicated hardware unit 436. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 436 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 436 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 436 to perform one or more operations described herein, such as evaluation of model and/or algorithm outputs, one-time or iterative updates to parameters, coefficients, weights, and/or biases, and/or any other operations such as vector and/or matrix operations as described in this disclosure.

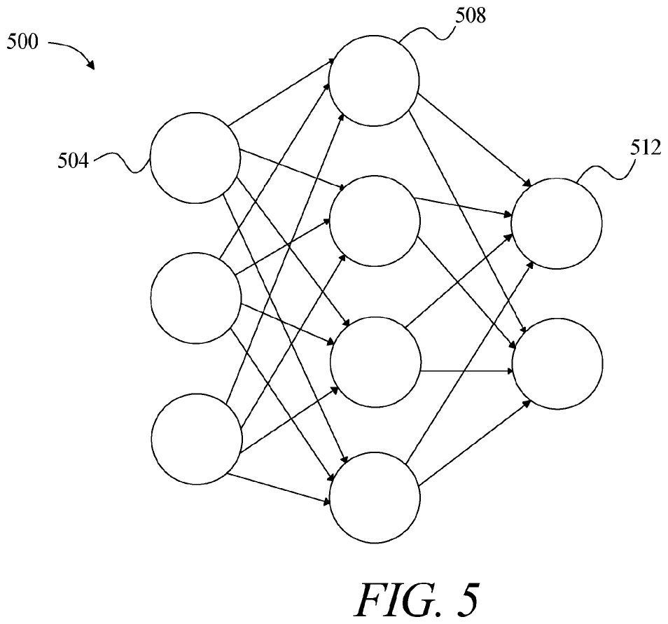

Referring now to FIG. 5, an exemplary embodiment of neural network 500 is illustrated. A neural network 500 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 504, one or more intermediate layers 508, and an output layer of nodes 512. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

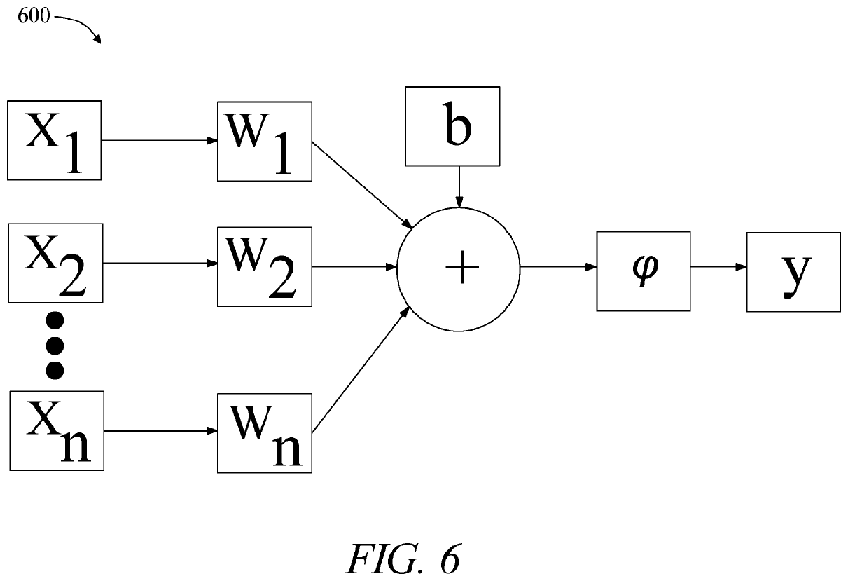

Referring now to FIG. 6, an exemplary embodiment of a node 600 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as f(x)=tanh²(x), a rectified linear unit function such as f(x)=max (0, x), a “leaky” and/or “parametric” rectified linear unit function such as f(x)=max (ax, x) for some a, an exponential linear units function such as

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tanh (\sqrt{2/π}(x+bx^{r}))) for some values of a, b, and r, and/or a scaled exponential linear unit function such as

$$f ( x ) = \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

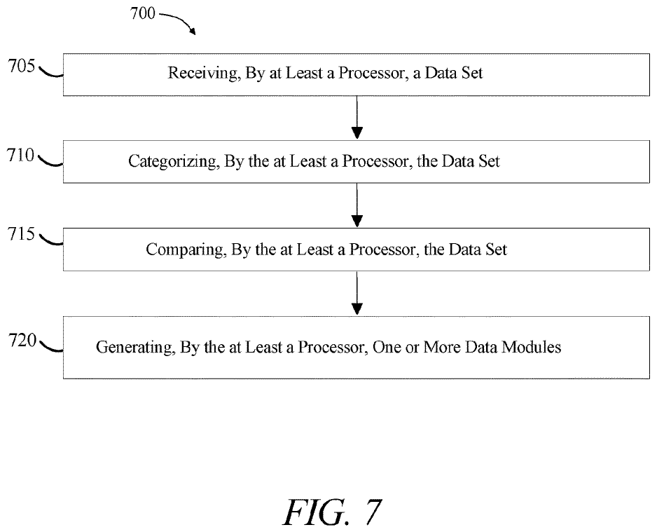

Referring now to FIG. 7, a method 700 for categorization and configuration of data sets is described. At step 705, method 700 includes receiving, by at least a processor, a data set. This may be implemented with reference to FIGS. 1-7 and without limitation.

With continued reference to FIG. 7, at step 710, method 700 includes, categorizing, by the at least a processor, the data set into at least one descriptor categorization. In some cases, categorizing, by the at least a processor, the product set into the at least one descriptor categorization includes classifying the data set using a product classifier. In some cases, categorizing, by the at least a processor, the data set into the at least one descriptor categorization includes selecting at least one descriptor categorization as a function of the classification. This may be implemented with reference to FIGS. 1-7 and without limitation.

With continued reference to FIG. 7, at step 715, method 700 includes comparing, by the at least a processor, the data set to one or more validity thresholds as a function of the at least one descriptor categorization. This may be implemented with reference to FIGS. 1-7 and without limitation.

With continued reference to FIG. 7, at step 720, method 700 includes generating, by the at least a processor, one or more data modules as a function of the comparison, wherein generating the one or more data modules includes selecting one or more end users as a function of the data set. In some cases, the one or more data module comprises at least one transport configuration. In some cases, each data module of the one or more data modules includes a quantitative element. In some cases, selecting an end user includes selecting one or more end users from a database. In some cases, each end user is associated with a user rating. In some cases, generating, by the at least a processor, one or more data modules as a function of the comparison includes receiving data module training data having a plurality of data sets correlated to a plurality of data modules, training a data module machine learning model as a function of the module training data and generating one or more data modules as a function of the data module training data. In some cases, method 700 further includes creating, by the at least a processor, a user interface data structure as a function of the one or more data modules and visually presenting, by at least a processor, one or more data modules as a function of the user interface data structure through a graphical user interface. In some cases, method 700 further includes receiving, by the at least a processor, a selection of the one or more data modules through the graphical user interface, and generating by the at least a processor, a communication datum as a function of the selection. This may be implemented with reference to FIGS. 1-7 and without limitation.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

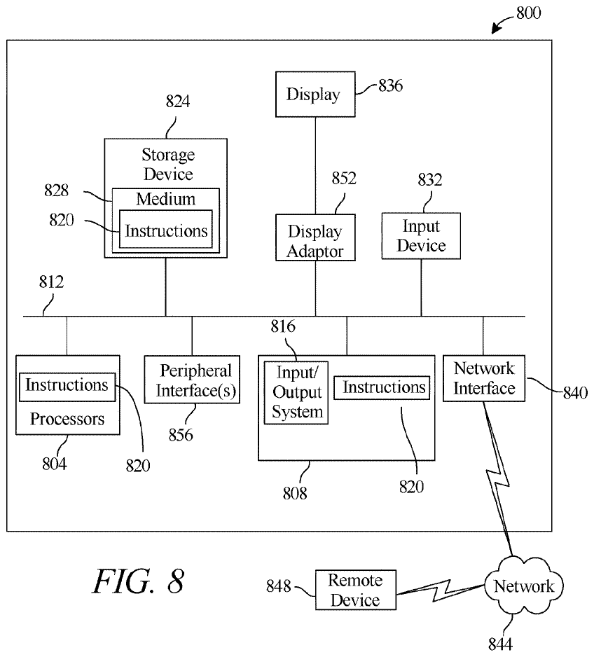

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display device 836. Examples of a display device include, but are not limited to, a liquid crystal display (LCD), a cathode ray tube (CRT), a plasma display, a light emitting diode (LED) display, and any combinations thereof. Display adapter 852 and display device 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, apparatuses and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for categorization and configuration of data sets, comprising:
a processor; and
a memory communicatively connected to the processor, the memory containing instructions configuring the processor to:
receive a data set;
categorize the data set into at least one descriptor categorization;
compare the data set to one or more validity thresholds as a function of the at least one descriptor categorization; and
generate one or more data modules as a function of the comparison, wherein generating the one or more data modules comprises selecting one or more end users as a function of the data set, wherein the one or more data modules each comprise a quantitative element including a total cost associated with the data set for a particular end user of the one or more end users.

2. The apparatus of claim 1, wherein categorizing the data set into the at least one descriptor categorization comprises classifying the data set using a descriptor classifier.

3. The apparatus of claim 2, wherein the descriptor classifier is trained with training data comprising a plurality of data sets correlated to a plurality of descriptor categorizations.

4. The apparatus of claim 1, wherein the one or more data modules comprises at least one transport configuration.

5. The apparatus of claim 1, wherein selecting the one or more end users comprises selecting the one or more end users from a database.

6. (canceled)

7. The apparatus of claim 1, wherein each end user is associated with a user rating.

8. The apparatus of claim 1, wherein generating one or more data modules as a function of the comparison comprises:
receiving data module training data comprising a plurality of data sets correlated to a plurality of data modules;
training a data module machine learning model as a function of the data module training data;
generating one or more data modules as a function of the data module machine learning model.

9. The apparatus of claim 1, where the processor is further configured to:
create a user interface data structure as a function of the one or more data modules; and
visually present one or more data modules as a function of the user interface data structure through a graphical user interface.

10. The apparatus of claim 9, wherein the processor is further configured to:
receive an input of the one or more data modules through the graphical user interface; and
generate a communication datum as a function of the input.

11. A method for categorization and configuration of data sets, the method comprising:
receiving, by at least a processor, a data set;
categorizing, by the at least a processor, the data set into at least one descriptor categorization;
comparing, by the at least a processor, the data set to one or more validity thresholds as a function of the at least one descriptor categorization; and
generating, by the at least a processor, one or more data modules as a function of the comparison, wherein generating the one or more data modules comprises selecting one or more end users as a function of the data set, wherein the one or more data modules each comprise a quantitative element including a total cost associated with the data set for a particular end user of the one or more end users.

12. The method of claim 11, wherein categorizing, by the at least a processor, the data set into the at least one descriptor categorization comprises classifying the data set using a descriptor classifier.

13. The method of claim 12, wherein the descriptor classifier is trained within training data comprising a plurality of data sets correlated to a plurality of descriptor categorizations.

14. The method of claim 11, wherein the one or more data module comprises at least one transport configuration.

15. The method of claim 11, wherein selecting the one or more end users comprises selecting the one or more end users from a database.

16. (canceled)

17. The method of claim 11, wherein each end user is associated with a user rating.

18. The method of claim 11, wherein generating, by the at least a processor, one or more data modules as a function of the comparison comprises:
receiving data module training data comprising a plurality of data sets correlated to a plurality of data modules;
training a data module machine learning model as a function of the data module training data; and
generating one or more data modules as a function of the data module machine learning model.

19. The method of claim 11, further comprising:
creating, by the at least a processor, a user interface data structure as a function of the one or more data modules; and
visually presenting, by at least a processor, one or more data modules as a function of the user interface data structure through a graphical user interface.

20. The method of claim 19, further comprising:
receiving, by the at least a processor, a selection of the one or more data modules through the graphical user interface; and
generating by the at least a processor, a communication datum as a function of the selection.
